(19) United States
(12) Patent Application Publication
(10) Pub. No.: US 2009/0226607 A1
(43) Pub. Date: Sep. 10, 2009

(54) APPLICATION OF MODIFIED POLYURETHANES

(76) Inventors: TONY J. BUSS, San Jose (CR); Edward Berardino, San Jose (CR)

Correspondence Address: BRINKS HOFER GILSON & LIONE, P.O. BOX 10395, CHICAGO, IL, 60610, US

(21) Appl. No.: 12/169,859

(22) Filed: Jul. 9, 2008

Related U.S. Application Data
(60) Provisional application No. 61/034,838, filed on Mar. 7, 2008.

(51) Int. Cl. B05D 1/36; B05D 3/12

(52) U.S. Cl. 427/205; 427/404; 427/405; 427/355

(57) ABSTRACT

A method of applying a metallic finish onto a substrate using a metallic mixture having a mix of polyurethane, polyurethane hardener, polyurethane solvent, and a metal additive. The method involves applying coats of polyurethane along with the metallic mixture onto a substrate and then burnishing the finish.

### CROSS-REFERENCE TO RELATED APPLICATION

This application claims the benefit of U.S. Provisional Application No. 61/034,838, filed Mar. 7, 2008, which is incorporated by reference in its entirety.

### TECHNICAL FIELD

The present invention is related to methods of coating and coating compositions. The invention concerns coating compositions primarily to provide a multi-coat system that includes polymer base coats and special effect pigments that provide a metallic finish onto a substrate.

### BACKGROUND OF THE INVENTION

Exterior furnishings can add significant cost to a building or home. Furnishings such as doors, window panes, and walls can be made of a wide variety of materials. Different metals and woods can be used with each varying in cost. Wood generally is an abundant material that may be used in tropical climates for exterior building furnishings. Aluminum is another material often used. Decorative colors also may be added to the furnishings to increase economic or aesthetic value. Expensive metal furnishings also may enhance the value of a home's external furnishings. If metal can not be provided, a metallic appearance may be desired instead.

Metallic pigments have been used in polyurethane based paints to add luster to the coating finish. They are sometimes used in polyurethane based paints to provide luster to automobiles. Polyurethane based paints and varnishes have been used as finishing coats on substrates such as wood. They provide abrasion-resistant and durable finishes popular on wooden decks, doors, and hardwood floors.

There is a need in the art for improved polyurethane based paints that provide a metallic appearance. There is also a need for improved and cost effective methods for making such paints and applying them onto a substrate.

### BRIEF SUMMARY

This disclosure describes a method of applying a metallic finish onto a substrate. A metallic mixture is used in applying the finish and includes a polyurethane useable as a base, a polyurethane hardener, a polyurethane solvent, and a metal. The method for applying the metallic finish includes agitating the metallic mixture to combine the ingredients and substantially maintaining the agitation throughout the application of the metallic mixture. At least about one coat of a polyurethane base is applied onto the substrate. At least about two coats of the metallic mixture are then applied onto the substrate. Once all the coats are applied, the substrate is burnished to improve the aesthetic appearance.

Also described herein is a method for applying a copper finish onto a substrate by applying a metallic mixture that includes a polyurethane useable as a base, a polyurethane hardener, a polyurethane solvent, and copper. The method for applying the finish includes agitating the metallic mixture to combine the ingredients and substantially maintaining the agitation throughout the application of the metallic mixture. At least about one coat of a polyurethane base is applied onto the substrate. Then, at least about three coats of the metallic mixture are applied onto the substrate. The substrate is then burnished after the application of all the coats.

Also described in this disclosure is a method for applying a bronze metallic finish onto a substrate by applying a copper metallic mixture and a bronze metallic mixture. The copper metallic mixture includes a polyurethane useable as a base, and polyurethane hardener, a polyurethane solvent, and copper. The bronze metallic mixture includes a polyurethane useable as a top coat, a polyurethane hardener, a polyurethane solvent, and bronze. The method includes agitating both the copper and bronze metallic mixtures and substantially maintaining the agitation during the application of the metallic mixtures onto the substrate. About two coats of a polyurethane base are applied onto the substrate and then two coats of the copper metallic mixture are applied. Next, about one coat of a polyurethane top coat is applied onto the substrate, followed by about four coats of the bronze metallic mixture. Another coat of a polyurethane top coat can be applied before burnishing.

There is also a method for applying a stainless steel finish onto a substrate. Similar to the method of applying a bronze metallic finish, a few coats of copper metallic mixture are applied onto a substrate followed by the application of a few coats of a stainless steel metallic finish. A number of coats of polyurethane are applied throughout the method before burnishing.

A substrate with a multi-layer coating with a metallic finish can include at least about one coat of a polyurethane base and at least about two coats of a metallic mixture. The metallic mixture can include a polyurethane useable as a base, a polyurethane hardener, a polyurethane solvent, and a metal.

Other systems, methods, features, and advantages will be, or will become, apparent to one with skill in the art upon examination of the following figures and detailed description. It is intended that all such additional systems, methods, features, and advantages be included within this description, be within the scope of the invention, and be protected by the following claims.

### DETAILED DESCRIPTION OF THE PRESENTLY PREFERRED EMBODIMENTS

The modified polyurethanes of the present invention can be added to substrates such as wood or aluminum to provide a metallic-looking finish or, in the case of aluminum, a different metallic-looking finish. When aluminum is the substrate, copper, bronze, or stainless steel finishes can be provided. There are many types of wood substrates suitable for use in the methods described herein including, but not limited to, pine, birch, cherry, oak, or teak. The metallic finishes used in the present invention can be used on many articles including, but not limited to, chairs, window panes, walls, doors, stools, furniture, crates, boxes, and barrels, flooring, handles, cabinets, and wood used in decks, siding, and roofing.

The mixtures of the present invention can be applied onto a substrate by using an air spray gun or powdered sprayer. Also useful are automatic or manual applicators for applying the finishes of the present invention onto small surface areas as well as large surface areas.

The method includes applying a metallic finish onto a substrate using a metallic mixture. The metallic mixture can contain pieces of metal and polyurethane coated onto a substrate along with a number of coats of polyurethanes. Once the metallic mixture and the layers of polyurethanes are coated onto a substrate, the metallic finish can be burnished, preferably with sandpaper. “Burnish,” as used herein, means to make smooth by or as if by rubbing. Burnishing can be accomplished through sanding.

The metallic mixture can include polyurethane, polyurethane hardener, polyurethane solvent, and a metal additive. Copper mixtures can include a polyurethane useable as a base, a polyurethane hardener, a polyurethane solvent, and copper. Bronze mixtures can include a polyurethane useable as a top coat, a polyurethane hardener, a polyurethane solvent, and bronze.

The number of polyurethane layers applied onto the substrate can depend on the type of metallic finish desired and the metal additive. The layered polyurethanes can include the same polyurethanes useable as base and top coats as described above. In some embodiments, the layered polyurethanes may not be the same as the polyurethanes used in the metallic mixtures.

The term “polyurethane”, as used herein, refers to a thermoplastic polymer which can be made crosslinkable and or produced by the reaction of a polyisocyanate and a polyol. The polymeric reaction product contains repeating carbamate ester or urethane linkages. Suitable polyurethanes for use in the present invention are known to be useful in the painting field and are available in the art.

Polyurethane hardeners, or curing agents, can be in solid form. Such hardeners can include polyisocyanate, a solid at room temperature, and can constitute useful crosslinkers for crosslinkable polyurethanes. Polyurethane solvents useful here include those used in electronics cleaning, paint stripping, printing, and urethane foam production. Suitable solvents may include hydrocarbons, such as toluene, xylene or cyclohexane; esters, such as ethyl glycolacetate, ethyl acetate or butyl acetate; amides, such as dimethylformamide or N-methylpyrrolidone; sulfoxides, such as dimethyl sulfoxide; ethers, such as diisopropyl ether or methyl tert-butyl ether; or cyclic ethers, such as tetrahydrofuran or dioxane. The solvents can be used separately or as mixtures.

The metal additives can include copper, bronze, or stainless steel. Copper is used to provide a copper finish. A bronze finish can be provided using a combination of copper and bronze. A stainless steel finish is provided using a combination of copper and stainless steel. Other metallic finishes can be provided by using a desired metal additive.

The metal additives are added preferably in a pulverized form such as in a powder. The pulverized form allows the metal to mix with the polyurethane. The powder size can vary and standard metallic powder sizes used in the art are applicable. Metallic powder having a mean particle size of from about 2.0 μm to about 18 μm can be used. Metallic powder having a mean particle size up to about 25 μm can be used as well. The metals can be provided also in some pulverized form other than in a powder, such as flakes.

The polyurethane useable as a base or top coat, polyurethane solvent, polyurethane hardener, and the metal additives are combined in a mixing container and agitated to provide a metallic mixture. The mixtures of the present invention can be made using a 3 gallon electric paint mixer and a transfer pump connected to a spray canister. The agitation can continue even after being mixed together. It is preferable that the mixture be kept agitated throughout its application onto the substrate. The agitation can be provided by stirring or shaking and the like. If the agitation is stopped, the components of the mixture may separate. Further agitation would be required to recombine the components and to regain a useable mixture. The agitation may be stopped for up to about 15 minutes without losing the mixture consistency. However, stopping the agitation for 1 to 2 hours would be excessive. As such, the mixtures should be substantially agitated throughout the application process.

To provide a bronze finish, two metallic mixtures may be used. Copper metallic mixture and a bronze metallic mixture may be applied onto the substrate at different times to provide a bronze finish. Each mixture may be prepared separately. The copper mixture may be applied first as a first metallic mixture before the bronze mixture as a second metallic mixture.

For a copper mixture, add the following to a mixer while agitating: about 250 ml to about 550 ml of polyurethane useable as a base, about 100 ml to about 300 ml polyurethane hardener, and about 100 ml to about 300 ml polyurethane solvent. About 6-12 pounds of copper powder are added slowly to the mixture until uniformly blended. A copper mixture also can be provided by combining the following while being agitated: about 400 ml of polyurethane useable as a base, about 200 ml polyurethane hardener, and about 200 ml polyurethane solvent. About 8.5 pounds of copper powder can be added slowly to the mixture until uniformly blended. Copper powder grade 301 dark can be used. One skilled in the art can adjust the proportions and amounts of polyurethane, polyurethane hardener, polyurethane solvent, and metal additives in the mixture to provide a desired finish.

A bronze mixture can be provided by combining, while agitating, about 450 ml to about 750 ml of polyurethane useable as a top coat, about 75 ml to about 250 ml polyurethane hardener, and about 150 ml to about 400 ml polyurethane solvent. About 8-15 pounds of bronze powder can be added until the mixture is uniformly blended. A bronze mixture also can be provided by combining, while constantly agitating, about 600 ml of the polyurethane useable as a top coat, about 150 ml polyurethane hardener, and about 300 ml polyurethane solvent. About 11 pounds of bronze powder is added until uniformly blended. Preferably, bronze powder grade 5790 dark bronze is used.

A stainless steel mixture can be provided by combining, while constantly agitating, about 450 ml to about 750 ml of polyurethane useable as a top coat, about 75 ml to about 250 ml polyurethane hardener, and about 150 ml to about 400 ml polyurethane solvent. About 8-15 pounds of stainless steel powder can be added slowly until the mixture is uniformly blended. A stainless steel mixture can be provided also by combining, while constantly agitating, about 600 ml of polyurethane useable as a top coat, about 150 ml polyurethane hardener, and about 300 ml polyurethane solvent. About 11 pounds of stainless steel powder can be added until uniformly blended.

The method of applying the metallic mixture can include applying onto the substrate at least one coat of a polyurethane base and then applying at least two coats of the metallic mixture. There are methods wherein two coats of the polyurethane base are applied onto the substrate. There are also methods wherein four coats of the metallic mixture are applied onto the substrate. The metallic mixture should be agitated substantially during application of the mixture.

The polyurethane and metallic mixture coats are applied using an applicator. An air spray gun, for example, can be used to apply the polyurethanes and metallic mixtures. A drying or curing step may follow after the application of each coat. After all coats are applied, the substrate can be allowed to dry for about 2 hours to about 24 hours or more. After drying, the substrate can be burnished until smooth or to shine. Sandpaper can be used. The substrate can be burnished after it is allowed to dry for 24 hours. 220 grit sandpaper can be used.

The method can include further steps to provide a second metallic finish. The second metallic mixture includes a polyurethane useable as a top coat, a polyurethane hardener, a polyurethane solvent, and a second metal. After the application of the first metallic mixture, and before the substrate is burnished, the second metallic mixture can be applied to give a second metallic finish. The first metallic mixture can include copper and the second metallic mixture can include bronze. Application of the bronze metallic mixture would give a bronze finish to the substrate. In some embodiments, the second metallic mixture may include stainless steel and application of that mixture would provide a stainless steel finish to the substrate.

The method for applying a second metallic finish includes applying about two coats of a polyurethane base coat and then about two coats of the first metallic mixture onto the substrate. At least about one coat of a polyurethane top coat is applied along with about two coats of the second metallic mixture. About four coats of the second metallic mixture can be applied. A polyurethane top coat is applied onto the substrate before burnishing.

A method of providing a copper finish onto a substrate by applying a metallic mixture comprising a polyurethane useable as a base, a polyurethane hardener, a polyurethane solvent, and copper can also be performed. The method includes applying onto the substrate at least one coat of a polyurethane useable as a base. The metallic mixture is agitated, and while it is agitated, at least three coats of the metallic mixture are applied onto the substrate. The mixture is burnished after the application of all coats. Four coats of the metallic mixture should be applied.

A method of providing a bronze metallic finish onto a substrate by applying the copper metallic mixture as described herein and the bronze metallic mixture as described herein is also disclosed. The method includes applying about two coats of a polyurethane base coat. The copper and bronze metallic mixtures can be are agitated, and while agitated, two coats of the copper metallic mixture can be applied onto the substrate. About one coat of polyurethane top coat can be applied along with about four coats of the bronze metallic mixture. About one coat of polyurethane top coat can be applied before burnishing.

The methods can be used to provide a substrate with a multi-layer coating having a metallic finish. The multi-layer coating includes at least about one coat of a polyurethane base and at least about two coats of a metallic mixture comprising a polyurethane useable as a base, a polyurethane hardener, a polyurethane solvent, and a metal. A copper finish can be provided onto the substrate when copper is used as the metal. A bronze finish can be provided also onto a substrate. The substrate can include further at least about one coat of a polyurethane top coat and at least about two coats of a second metallic mixture. The second metallic mixture can include a polyurethane useable as a top coat, a polyurethane hardener, a polyurethane solvent, and a second metal. The second metal can be bronze or stainless steel.

A kit for providing a metallic finish onto a substrate includes a polyurethane useable as a base, a polyurethane hardener, a polyurethane solvent, and a metal. The polyurethane, polyurethane hardener, polyurethane solvent, and metal can be packaged separately and can be later combined to practice the method discussed herein. The above ingredients can be packaged in cans or flexible plastic bags.

It is understood that the order of the application of layers of polyurethane and metallic mixtures can vary in different embodiments of the present invention. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method of applying a metallic finish onto a substrate by applying a metallic mixture comprising a polyurethane useable as a base, a polyurethane hardener, a polyurethane solvent, and a metal, the method comprising:
applying onto the substrate at least about one coat of a polyurethane base;
agitating the metallic mixture and, while the metallic mixture is agitated, applying onto the substrate at least about two coats of the metallic mixture.

2. The method of claim 1 further comprising burnishing the finish after the application of all coats.

3. The method of claim 1 wherein the substrate is wood or aluminum.

4. The method of claim 1 comprising applying onto the substrate about two coats of the polyurethane for use as a base.

5. The method of claim 1 comprising applying onto the substrate about four coats of the metallic mixture.

6. The method of claim 1 wherein the metal is a powder.

7. The method of claim 1 wherein the metal comprises copper or bronze.

8. The method of claim 1 wherein the finish is applied using an air spray gun.

9. The method of claim 2 wherein burnishing is performed with sandpaper.

10. The method of claim 1 further comprising applying a second metallic mixture comprising a polyurethane useable as a top coat, a polyurethane hardener, a polyurethane solvent, and a second metal.

11. The method of claim 10 wherein the second metal is bronze.

12. The method of claim 10 wherein the second metal is stainless steel.

13. The method of claim 10 wherein the second metal is a powder.

14. The method of claim 10 further comprising applying onto the substrate at least about one coat of a polyurethane top coat after the application of the at least about two coats of the second metallic mixture.

15. The method of claim 14 further comprising applying onto the substrate at least about three coats of the second metallic mixture.

16. The method of claim 14 further comprising applying onto the substrate at least about one additional coat of the polyurethane top coat.

17. The method of claim 14 further comprising applying onto the substrate about four coats of the second metallic mixture.

18. The method of claim 10 wherein the metallic mixture comprises copper and the second metallic mixture comprises bronze.

19. The method of claim 10 wherein the metallic mixture comprises copper and the second metallic mixture comprises stainless steel.

20. A method of providing a copper finish onto a substrate by applying a metallic mixture comprising a polyurethane useable a base, a polyurethane hardener, a polyurethane solvent, and copper, the method comprising:
applying onto the substrate at least about one coat of a polyurethane base;
agitating the metallic mixture and, while the metallic mixture is agitated, applying onto the substrate at least about three coats of the metallic mixture.

21. The method of claim 20 further comprising burnishing the finish after the application of all coats.

22. The method of claim 20 comprising applying onto the substrate about four coats of the metallic mixture.

23. The method of claim 20 wherein the copper is a powder.

24. A substrate with a multi-layer coating with a metallic finish, the multi-layer coating comprising:
at least about one coat of a polyurethane base; and
at least about two coats of a metallic mixture comprising a polyurethane useable as a base, a polyurethane hardener, a polyurethane solvent, and a metal.

25. The substrate of claim 24 wherein the substrate is wood or aluminum.

26. The substrate of claim 24 wherein the metal is a powder.

27. The substrate of claim 24 wherein the metal is copper, bronze, or stainless steel.

28. The substrate of claim 24 further comprising at least about one coat of a polyurethane top coat and at least about two coats of a second metallic mixture comprising a polyurethane useable as a top coat, a polyurethane hardener, a polyurethane solvent, and a second metal.

29. The substrate of claim 28 wherein the metal comprises copper and the second metal comprises bronze.

30. The substrate of claim 28 wherein the second metal is bronze or stainless steel.
